(19) United States
(12) Patent Application Publication
(10) Pub. No.: US 2008/0100100 A1
(43) Pub. Date: May 1, 2008

(54) Vehicle Roof Assembly and Method of Installing a Vehicle Roof Assembly on a Vehicle

(75) Inventor: George Huisman, Commerce Township, MI (US)

Correspondence Address: QUINN LAW GROUP, PLLC, 39555 ORCHARD HILL PLACE, SUITE # 520, NOVI, MI, 48375, US

(73) Assignee: CLASSIC DESIGN CONCEPTS, LLC, Novi, MI (US)

(21) Appl. No.: 11/928,182

(22) Filed: Oct. 30, 2007

Related U.S. Application Data
(60) Provisional application No. 60/863,670, filed on Oct. 31, 2006.

(51) Int. Cl. B62D 25/06; B21D 53/00

(52) U.S. Cl. 296/215; 29/897; 296/214

(57) ABSTRACT

A vehicle roof assembly is provided including a substantially transparent panel having an outer periphery and opposing inner and outer surfaces. The roof assembly also includes a preformed, one-piece support member having opposing upper and lower surfaces defining an opening, and a stepped region configured to mate with and thereby support the substantially transparent panel such that the substantially transparent panel covers the opening and the outer surface is flush with the upper surface of the support member. A trim member is disposed about the outer periphery of the substantially transparent panel to create a water-tight seal. The stepped region preferably extends continuously about an inner periphery of the support member to engage with the entire outer periphery of the substantially transparent panel. A headliner trim member preferably attaches a headliner to the stepped region such that the support member is substantially nonvisibile from the inside of the vehicle.

### CROSS-REFERENCE TO RELATED APPLICATIONS

This application claims priority to U.S. Provisional Patent Application No. 60/863,670, filed on Oct. 31, 2006, which is hereby incorporated by reference in its entirety.

### TECHNICAL FIELD

The present invention relates generally to motor vehicle roof structures, and more specifically to sunroofs, moonroofs, and similar assemblies, and methods of assembling the same on a motor vehicle.

### BACKGROUND OF THE INVENTION

Sunroofs, moonroofs and other similar assemblies (referred to collectively hereinafter as “roof assemblies”) are traditionally defined by an opening in the roof or upper surface of a motorized vehicle passenger compartment. Such roof assemblies generally include longitudinally opposing header or rail members and adjoining, laterally spaced rail members positioned about the periphery of the opening. A transparent panel, usually fabricated from glass or a transparent plastic material, is thereafter seated in the opening and attached to the vehicle with adhesives, gaskets, or fasteners. The glass of a vehicle roof assembly must be mounted securely enough to withstand the forces of high-speed winds created during all ranges of vehicle operation, and must properly seal for weather proofing purposes. Furthermore, the roof assembly must generally present a neat, aesthetically appealing appearance and have a low profile for minimal wind resistance.

Vehicles are traditionally provided with roof assemblies either as an original equipment option or as a retrofitted add-on. Sunroofs and moonroofs typically occupy only a portion of the vehicle roof area with the structural roof (i.e., the load-bearing portion of the roof structure, whether steel or fiberglass) being visible around the sunroof. Sunroofs and moonroofs are often centered in the roof or are T-shaped.

It would be desirable to provide a vehicle roof assembly enabling ease of installation on a vehicle, and having a streamlined appearance to improve aerodynamics. Additionally, it would be advantageous to reduce the number of components necessary to fabricate the roof assembly in order to reduce costs and to simplify and expedite assembly.

### SUMMARY OF THE INVENTION

A vehicle roof assembly is provided that is capable of being prefabricated and completely assembled prior to installation on a motor vehicle, and requires a minimal number of components to reduce overall costs and maximize the ease of installation. The vehicle roof assembly preferably covers substantially the entire roof of the vehicle, and provides a flush fit, originally-equipped look. A method of installing a vehicle roof assembly to achieve this appearance and provide these benefits is also provided.

According to one aspect of the present invention, there is provided a vehicle roof assembly for use with a motorized vehicle having vehicle roof structure. The roof assembly includes a substantially transparent panel having an inner surface substantially opposing an outer surface, and a support member having substantially opposing upper and lower surfaces defining an opening therethrough and thus an inner periphery. The upper surface has a stepped region that extends inward from the inner periphery, and is configured to mate with and thereby support the substantially transparent panel at a first portion such that the substantially transparent panel covers the opening and the outer surface is substantially flush with a second portion of the stepped region. A trim member is preferably disposed continuously about an outer periphery of the substantially transparent panel and the inner periphery of the support member. Accordingly, the trim member is preferably configured to secure the substantially transparent panel to the support member and thereby create a substantially water tight seal therebetween. Ideally, the support member is a single preformed, one-piece component. The vehicle roof assembly preferably comprises not more than these three primary components—i.e., the support member, the transparent panel, and the trim member.

In an alternative embodiment, an adhesive member may be disposed between the inner surface of the substantially transparent panel and the stepped region of the support member to secure the two members together. In a similar regard, an adhesive member may be disposed between the lower surface of the support member and the vehicle roof structure to secure the support member to the motorized vehicle.

According to another alternative embodiment, the stepped region preferably extends continuously about the inner periphery of the support member. In this instance, the stepped region is configured to operatively engage with the entire outer periphery of the substantially transparent panel.

According to yet another alternative embodiment, a headliner is mounted adjacent the underside of the vehicle roof structure and configured to substantially cover the underside of the vehicle roof structure without obstructing the opening. Preferably, a headliner trim member attaches the headliner to the first portion of the stepped region to thereby substantially cover the lower surface of the support member.

A vehicle may be originally equipped or retrofitted with the roof assembly. The vehicle roof assembly preferably covers substantially the entire vehicle roof. In this instance, which may be referred to as the flush fit panoramic glass roof assembly, the outer periphery of the roof assembly (i.e., the outer periphery of the support member) coincides with the outer periphery of the vehicle roof. In this embodiment, the transparent panel and roof opening may be nearly as large as the vehicle roof.

Because the roof assembly overlays substantially the entire vehicle roof, and the transparent panel is nested by the support member to provide a relatively flush appearance, the added height above the existing roof (i.e., the non-glass, typically steel, vehicle roof structure) is not apparent to the observer, thus making the roof assembly appear to be originally equipped. However, structural integrity of the vehicle roof is not compromised as a consequence of installing the vehicle roof assembly.

In another aspect of the present invention, a vehicle is provided comprising a preformed, one-piece support member secured to a roof, a substantially transparent panel, and a trim member. The roof has a first surface defining a first opening. The substantially transparent panel has an inner surface substantially opposing an outer surface and an outer periphery extending continuously therebetween. The support member has substantially opposing upper and lower surfaces defining a second opening therethrough and, thus, inner and outer peripheries, and a stepped region extending inward from the inner periphery of the support member. The trim member is disposed between the outer periphery of the substantially transparent panel and the inner periphery of the support member to thereby create a substantially water tight seal therebetween. The substantially transparent panel is supported by the support member on the stepped region to cover the second opening such that the outer surface of the transparent member is substantially flush with the upper surface of the preformed member.

The vehicle may include a headliner that is mounted adjacent to and thereby substantially covering an underside of the roof without obstructing the first or second openings. A headliner trim member preferably attaches the headliner to the stepped region and thereby renders the support member substantially nonvisibile from the inside of the vehicle. In this instance, the vehicle roof is sandwiched between the vehicle roof assembly and the headliner when the assembly is supported by the roof structure.

An additional aspect of the present invention is to provide an improved method for the installation of a vehicle roof assembly on a motor vehicle having vehicle roof structure. Specifically, the method includes: providing a substantially transparent panel with an outer surface; providing a preformed, one-piece support member having substantially opposing upper and lower surfaces defining a opening therethrough and an inner periphery, and a stepped region extending inward from said inner periphery; disposing the transparent panel to abut the stepped region and thereby cover the opening; securing the transparent panel to the stepped region such that the outer surface is substantially flush with the upper surface of the support member; and securing the support member to an outer surface of the vehicle roof structure such that the support member covers at least a portion of the outer surface.

The method preferably includes the additional steps of applying a trim member continuously about an outer periphery of the substantially transparent panel prior to disposing the substantially transparent panel to abut the stepped region, and securing a head liner to the stepped region to thereby render the support member substantially nonvisibile from the inside of the motorized vehicle. The method may also include forming an aperture in the vehicle roof structure prior to securing the support member to the outer surface of the vehicle roof structure or, alternatively, performing the vehicle roof structure with an aperture.

The above features and advantages, and other features and advantages of the present invention will be readily apparent from the following detailed description of the preferred embodiments and best modes for carrying out the invention when taken in connection with the accompanying drawings and the appended claims.

### BRIEF DESCRIPTION OF THE DRAWINGS

FIG. 1 is an isometric or perspective illustration in an exploded view of a vehicle roof assembly in accordance with one embodiment of the present invention;

FIG. 2 is an exemplary motorized vehicle having the vehicle roof assembly of FIG. 1 assembled and installed thereupon;

FIG. 3 is a cross-sectional view taken along line A-A of FIG. 2 illustrating the vehicle roof assembly, vehicle roof structure, and headliner; and

FIG. 4 is a flow chart illustrating a method of installing a vehicle roof assembly on a vehicle.

### DESCRIPTION OF THE PREFERRED EMBODIMENTS

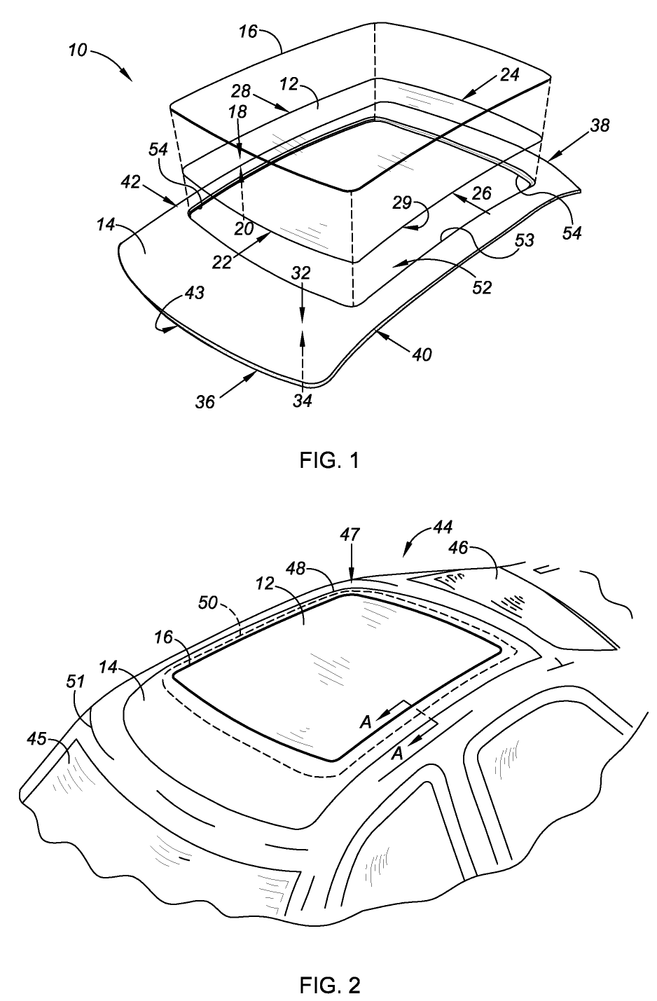

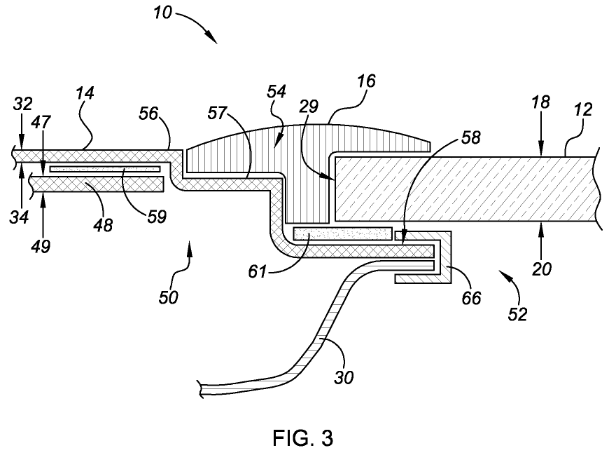

Referring to the Figures, wherein like reference numbers refer to like components throughout the several views, a flush fit panoramic glass vehicle roof assembly (referred to hereinafter as “vehicle roof assembly”) is indicated generally as 10 in FIG. 1. As shown in FIG. 1, the vehicle roof assembly 10 includes a substantially transparent panel 12, a support member 14, and a trim member 16. The substantially transparent panel 12 includes a first, outer surface 18 opposing a second, inner surface 20, and edge surfaces defining a periphery therebetween—i.e., a forward edge surface 22, a rearward edge surface 24, a first side surface 26, and a second side surface 28 collectively define the outer periphery, indicated generally as 29, of the substantially transparent panel 12. The support member 14 includes a first, upper surface 32 opposing a second, lower surface 34, and edge surfaces defining a periphery therebetween—i.e., a forward edge surface 36, a rearward edge surface 38, a first side surface 40 and a second side surface 42 collectively define the outer periphery, indicated generally as 43, of the support member 14. The vehicle roof assembly 10 also includes an optional headliner 30, as indicated in FIG. 3.

Referring to FIGS. 1 through 3, the substantially transparent panel 12 is preferably a preformed, one-piece generally rectangular element configured to abut against a surface of the support member 14, as will be described in further detail hereinbelow. As used herein, the term “one-piece” should be defined or interpreted to indicate an element or component that consists solely of a single, unitary piece—i.e., the component is not fabricated from two or more pieces joined together. In the preferred embodiment, the substantially transparent panel 12 is preformed glass or a substantially transparent plastic composite. However, the substantially transparent panel 12 may comprise more than one single piece, and may be fabricated from any functionally suitable material.

The support member 14 is preferably a preformed, one-piece substantially rectangular element configured to abut against and overlay an upper surface of a vehicle roof structure, such as outer surface 47 of vehicle roof 48 in FIG. 2. In the preferred embodiment, the support member 14 is stamped from steel or aluminum sheet metal. However, the support member 14 may also be fabricated from plastic, plastic composites, fiberglass, or other suitable materials. The upper surface 32 and lower surface 34 of the support member 14 define a first aperture or opening therethrough, indicated generally at 52. The first opening 52 is cut or preformed in the support member 14.

Ideally, the trim member 16 is also a preformed, one-piece element configured to extend continuously about and abut the entire outer periphery 29 of the substantially transparent panel 12—i.e., forward edge surface 22, rearward edge surface 24, and first and second side surfaces 26, 28. It is also preferred that the trim member 16 be configured to extend between the substantially transparent panel 12 and an inner periphery 53 of the support member 14, as well as along a portion of the outer surface 18 of the substantially transparent panel 12 and the upper surface 32 of the support member 14 (as best seen in FIG. 3). In the preferred embodiment, the trim member 16 is fabricated from a trim molding, such as is manufactured by Flex Trim Corp. of Redlands, Calif., and has a T-shaped cross-section (as best seen in FIG. 3).

The support member 14 includes a “stepped” portion or region, indicated generally at 54 in FIGS. 1 and 3, extending inward from the inner periphery 53. The stepped region 54 includes a first, upper-most step portion, indicated as 56, a second, lowest step portion, shown generally at 58, and a third, intermediate step portion 57 therebetween. The stepped region 54 is illustrated in FIGS. 1 and 3 as extending continuously about the inner periphery 53 of the support member 14. Alternatively, the stepped region 54 may include a plurality of separate portions extending individually from the inner periphery 53 of the support member 14.

Referring to FIG. 2, a representative motorized vehicle, identified generally by reference numeral 44, is depicted in partial fragmentary view with the vehicle roof assembly 10 of FIG. 1 installed thereon. Although the vehicle 44 is depicted in FIG. 1 as a standard passenger car, the present invention can be incorporated into any vehicle platform, such as, but not limited to, light trucks, heavy duty vehicles, minivans, buses, airplanes, etc., without departing from the scope of the claimed invention.

As is typical, the vehicle 44 includes a front windshield 45, a rear window 46, and a vehicle roof (or roof structure) 48 having a roof outer surface 47. Other configurations of vehicle roofs such as a multi-panel roof are also possible within the scope of the invention. The support member 14 is abutted against the roof outer surface 47 and thereby supported around its perimeter by the vehicle roof structure 48. The vehicle roof 48 defines a second aperture or opening, shown hidden in FIG. 2 as 50, that is cut or preformed therein. The roof opening 50 shown in FIG. 3 is pre-cut or preformed in the vehicle roof 48 if the vehicle 44 is retrofitted with the vehicle roof assembly 10. The second opening 50 is cut to ensure the vehicle roof structure 48 provides adequate vehicle integrity as well as support for the vehicle roof assembly 10. Alternatively, the vehicle roof structure 48 and, thus, the vehicle 44 may be originally equipped (i.e., originally manufactured) with the vehicle roof assembly 10, thereby negating the need for the second opening 50.

FIG. 2 illustrates the vehicle roof assembly 10 abutting and overlaying substantially all, but not the entire vehicle roof 48. In an alternate embodiment of the present invention, the outer periphery 43 of the support member 14—i.e., forward and rearward edge surfaces 36, 38, and first and second side surfaces 40, 42, may align coterminous with an outer periphery 51 of the vehicle roof 48. In yet another alternate embodiment of the invention, the forward edge 36 and the rear edge 38 of the support member 14 may align coterminous with the upper edge of the front windshield 45 and the upper edge of the rear window 46, respectively.

As is apparent in FIG. 2, the trim member 16 is disposed between the outer periphery 29 of the substantially transparent panel 12 and the inner periphery 53 of the support member 14 to thereby streamline and weather proof the vehicle roof assembly 10. It is also preferred that the trim member 16 be operable to secure the substantially transparent panel 12 to the support member 14, e.g., through a press fit or otherwise.

Referring again to FIG. 3, the lower surface 34 of the support member 14 abuts, overlays, and is supported on the outer surface 47 of the vehicle roof panel 48. A first adhesive strip 59, preferably urethane based, is disposed between the outer surface 47 of the vehicle roof structure 48 and the lower surface 34 of the support member 14 to securely adhere the two members. In a similar respect, a second adhesive strip 61 is preferably disposed between the lowest step portion 58 of the support member 14 and a portion of the inner surface 20 of the substantially transparent panel 12 to securely adhere the two members. The first and second adhesive strips 59, 61 are preferably applied in a continuous bead encircling their respective openings 50, 52. The substantially transparent panel 12 is preferably supported on the lowest step portion 58 and nested by the stepped region 54 so that the outer surface 18 of the substantially transparent panel 12 sits substantially flush with the upper-most step portion 56 and, thus, the upper surface 32 of the support member 14.

FIGS. 2 and 3 depict a continuous mating, nesting, or engagement along the entire outer periphery 29 of the substantially transparent panel 12 and the inner periphery 53 of the support member 14 between the inner surface 20 and the lowest portion 58 of the stepped region 54 to provide support for the substantially transparent panel 12. However, the substantially transparent panel 12 may be sufficiently supported by the support member 14 by abutting and being secured to the stepped region 54 at an area which is less than the entire outer periphery 29 of the substantially transparent panel 12 (e.g., engaging just surfaces 18 and 20 or surfaces 22 and 24.) Regardless, the substantially transparent panel 12 is sufficiently sized and shaped to provide a closure panel suitable for substantially covering said first opening 52.

The headliner 30 is installed from inside the vehicle to substantially cover an inner surface 49 and, thus, vehicle roof structure 48 from view, while leaving the view through the second opening 50 unobstructed. Accordingly, an occupant within the vehicle will view the front windshield 45, the headliner 30 and the substantially transparent panel 12. Preferably, the headliner 30 extends sufficiently to substantially cover the stepped region 54 and thereby render the support member 14 substantially nonvisibile from the inside of the vehicle 44. The headliner 30 is preferably a one-piece component, secured to the lower stepped portion 54 of the support member 14 by a head liner trim 66, forming a generally rectangular boundary below the substantially transparent panel 12. Within the scope of the invention, however, the headliner 30 may be one or more separate pieces, and provide a boundary of any geometry below the substantially transparent panel 12 (i.e. circular, elliptical square, triangular, etc. . . . ) Similarly, the headliner trim member 66 may comprise one continuous strip, or numerous individual clamp elements with U-shaped cross sections. The headliner 30 may also be customized to receive vehicle interior components such as sun visors and overhead storage compartments (not shown), which may be mounted directly to the headliner 30 or extend through to mount or attach to the vehicle roof 48—e.g., at the inner surface 49. As is apparent from FIGS. 1 through 3, vehicle occupants enjoy a panoramic view through the vehicle roof assembly 10.

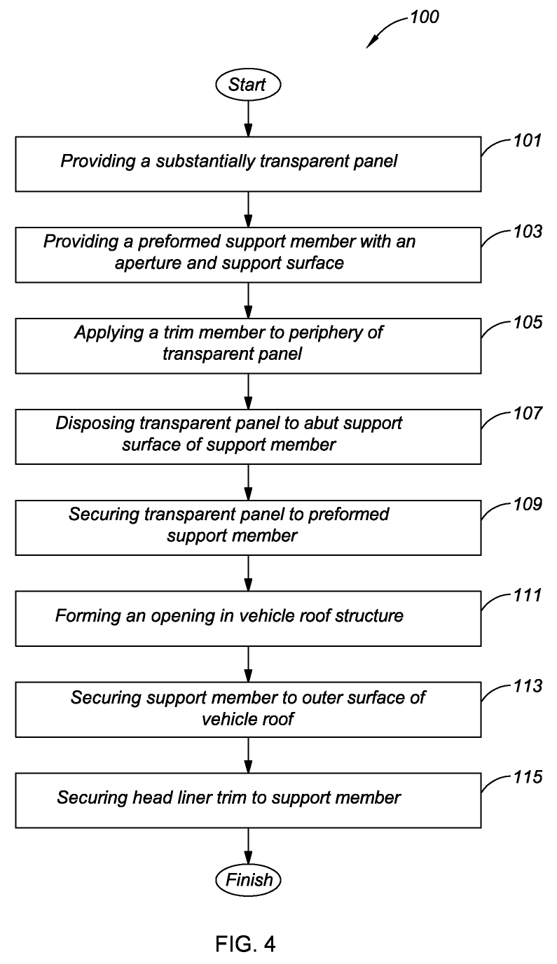

With reference now to the flow chart in FIG. 4, a method of installing a vehicle roof assembly on a motorized vehicle, namely the method of installing the vehicle roof 10 on vehicle 44 is shown generally as 100 in accordance with a preferred embodiment of the present invention. The method 100 is described with respect to the structure illustrated in FIGS. 1 through 3. However, the method may also be applied to other vehicle platforms and with variations to the vehicle roof assembly embodiments.

Referring to FIG. 4, the method 100 begins with providing a substantially transparent panel 12 with an outer surface 18 as step 101. The method 100 also includes at step 103 providing a preformed, one-piece support member 14 with substantially opposing upper and lower surfaces 32, 34 defining an opening 52 therethrough and an inner periphery 53, and a stepped region 54 extending inward from at least a portion of the inner periphery 53. Optionally, the method 100 may also include preforming the support member 14 as well.

After step 103, a trim member 16 is preferably applied to the outer periphery 29—i.e., periphery surfaces 22, 24, 26, and 28, of the transparent panel 12, as step 105. Subsequently, the method 100 includes step 107, in which the substantially transparent panel 12 is disposed so as to abut the stepped region 54—i.e., placing the inner surface 20 of the transparent panel 12 so as to interface with the lowest step portion 58, and thereby cover the opening 52. Thereafter or contemporaneously therewith, the substantially transparent panel 12 is fixedly secured, attached or adhered to the stepped region 54, e.g., secured by second adhesive strip 61, such that the outer surface 18 is substantially flush with the upper surface 32 of the support member 14, as step 109. Within the scope of the invention, steps 107 and 109 are chronologically interchangeable.

With continuing reference to FIG. 3, if the vehicle roof assembly 10 is retrofitted on the vehicle 44, prior to, contemporaneous with, or subsequent to fabrication of the roof assembly 10—i.e., steps 101 to 109, the vehicle 44 is prepared for installation of the roof assembly 10 by forming or cutting opening 50 in the vehicle roof structure 48 in step 111. It should be appreciated that if the vehicle roof assembly 10 is provided as original equipment on the vehicle 44, the forming step 111 may be omitted as the vehicle roof structure 48 may be preformed with an opening and a stepped region.

In step 113 of method 100, an lower surface 34 of the support member 14 is positioned on the roof panel 48—i.e., to abut against the roof outer surface 47, as illustrated in FIGS. 2 and 3, and fixedly secured thereto, e.g., by the first adhesive strip 59. When the method 100 is performed through step 113, the vehicle 44 of FIG. 2 appears to have a substantially uninterrupted roof outer surface from the windshield 45, through the roof assembly 10, and to the rear window 46, with the roof assembly abutting and overlaying substantially the entire vehicle roof 48, and the transparent panel 12 nesting within the stepped region 54 such that the outer surface 18 of the panel 12 sits substantially flush with upper surface 32 of the support member 14.

The method 100 preferably also includes step 115, securing the headliner 30 to the roof assembly 10. For example, the headliner is disposed so as to abut the lowest step portion 58 of the support member 14, as shown in FIG. 3, below the substantially transparent panel 12. The headliner trim member 66 is applied to the headliner 30 and the inner periphery 53 of the support member 14 at aperture 52 to secure the former to the latter. Step 115 may be performed at any time after completion of step 109. Steps 101 through 109 (assembly of the vehicle roof assembly 10) may be performed in the absence of the vehicle 44.

While the best modes for carrying out the invention have been described in detail, those familiar with the art to which this invention relates will recognize various alternative designs and embodiments for practicing the invention within the scope of the appended claims. As set forth in the claims, various features shown and described in accordance with the various different embodiments of the invention illustrated may be combined.

1. A vehicle roof assembly for use with a motorized vehicle having vehicle roof structure, comprising:
a substantially transparent panel having an inner surface substantially opposing an outer surface; and
a support member having substantially opposing upper and lower surfaces defining an opening therethrough and thus an inner periphery, said upper surface having a stepped region extending inward from at least a portion of said inner periphery and configured to mate with and thereby support said substantially transparent panel at a first portion such that said substantially transparent panel covers said opening and said outer surface is substantially flush with a second portion of said stepped region.

2. The vehicle roof assembly of claim 1, wherein said support member consists of a single preformed, one-piece panel.

3. The vehicle roof assembly of claim 1, further comprising:
a trim member disposed continuously about an outer periphery of said substantially transparent panel and said inner periphery of said support member.

4. The vehicle roof assembly of claim 3, wherein said trim member is configured to secure said substantially transparent panel to said support member and thereby create a substantially water tight seal therebetween.

5. The vehicle roof assembly of claim 1, further comprising:
an adhesive member disposed between said inner surface and said stepped region to secure said substantially transparent panel to said support member.

6. The vehicle roof assembly of claim 1, further comprising:
an adhesive member disposed between said lower surface and the vehicle roof structure to secure said support member to the motorized vehicle.

7. The vehicle roof assembly of claim 1, wherein said stepped region extends continuously about said inner periphery of said support member and thereby operatively engages with the entire outer periphery of said substantially transparent panel.

8. The vehicle roof assembly of claim 1, further comprising:
a headliner adapted to be mounted adjacent the underside of the vehicle roof structure and configured to substantially cover the underside of the vehicle roof structure without obstructing said opening.

9. The vehicle roof assembly of claim 8, further comprising:
a headliner trim member configured to attach said headliner to said first portion of said stepped region to thereby substantially cover the lower surface of said support member.

10. A vehicle comprising:
a roof having a first surface defining a first opening;
a substantially transparent panel having an inner surface substantially opposing an outer surface and an outer periphery extending continuously therebetween;
a preformed, one-piece support member operatively secured to said roof and having substantially opposing upper and lower surfaces defining a second opening therethrough and inner and outer peripheries, and a stepped region extending inward from at least a portion of said inner periphery of said support member; and
a trim member disposed continuously between said outer periphery of said substantially transparent panel and said inner periphery of said support member to thereby create a substantially water tight seal therebetween;
wherein said substantially transparent panel is supported by said support member on said stepped region to cover said second opening such that said outer surface of said transparent member is substantially flush with said upper surface of said preformed member.

11. The vehicle of claim 10, further comprising:
an adhesive member disposed between said inner surface and said stepped region to secure said substantially transparent panel to said support member.

12. The vehicle of claim 11, wherein said stepped region extends continuously from said inner periphery of said support member and thereby configured to operatively engage with the entire outer periphery of said substantially transparent panel.

13. The vehicle of claim 12, further comprising:
a headliner adapted to be mounted adjacent to and thereby substantially cover an underside of said roof without obstructing said first or second openings.

14. The vehicle of claim 13, further comprising:
a headliner trim member configured to attach said headliner to said stepped region and thereby render said support member substantially nonvisibile from the inside of the vehicle.

15. The vehicle of claim 14, wherein said inner surface of said support member is abutting against and overlaying substantially all of said first surface of said roof.

16. A method of installing a vehicle roof assembly on a motorized vehicle having vehicle roof structure, comprising:
providing a substantially transparent panel with an outer surface;
providing a one-piece support member having substantially opposing upper and lower surfaces defining an opening therethrough and an inner periphery, and a stepped region extending inward from at least a portion of said inner periphery;
disposing said transparent panel to abut said stepped region and thereby cover said opening;
securing said transparent panel to said stepped region such that said outer surface is substantially flush with said upper surface of said support member; and
securing said support member to an outer surface of the vehicle roof structure such that said support member covers at least a portion of said outer surface.

17. The method of claim 16, further comprising:
forming an aperture in the vehicle roof structure prior to securing said support member to said outer surface of the vehicle roof structure.

18. The method of claim 16, wherein the vehicle roof structure is preformed with an aperture.

19. The method of claim 16, further comprising:
applying a trim member continuously about an outer periphery of said substantially transparent panel prior to disposing said substantially transparent panel to abut said stepped region.

20. The method of claim 16, further comprising:
securing a head liner to said stepped region to thereby render said support member substantially nonvisibile from the inside of the motorized vehicle.
